(19) United States
(12) Patent Application Publication
(10) Pub. No.: US 2013/0115458 A1
(43) Pub. Date: May 9, 2013

(54) THERMOPLASTIC ORGANIC FIBER, METHOD FOR PREPARING THE SAME, FIBER COMPOSITE BOARD USING THE SAME AND METHOD FOR PREPARING THE BOARD

(71) Applicants: Chan Whan Park, Seoul (KR); Seung Gyoo Kim, Busan (KR)

(72) Inventors: Chan Whan Park, Seoul (KR); Seung Gyoo Kim, Busan (KR)

(73) Assignee: LI&S CO., LTD., Cheonan-si, Chungcheongnam-do (KR)

(21) Appl. No.: 13/809,841

(22) PCT Filed: Jul. 12, 2011
(86) PCT No.: PCT/KR11/05113

§ 371 Date: Jan. 11, 2013

(30) Foreign Application Priority Data
Jul. 12, 2010 (KR) 10-2010-0066959

(51) Int. Cl. C08L 97/02

(52) U.S. Cl. CPC C08L 97/02
USPC 428/401; 525/333.7; 525/190; 525/240; 524/9; 264/8; 428/516; 428/483

(57) ABSTRACT

Provided are thermoplastic organic fibers including a copolymerized resin of maleic anhydride with polypropylene, a method for preparing the same, a fiber composite board using the thermoplastic organic fibers as a matrix, and a method for manufacturing the fiber composite board. The thermoplastic organic fibers solve the problem of a limitation in improvement of strength caused by low wettability and adhesion between the thermoplastic organic materials used as a matrix according to the related art and reinforcing fibers.

### TECHNICAL FIELD

This disclosure relates to thermoplastic organic fibers, a method for preparing the same, a fiber composite board using the thermoplastic organic fibers, and a method for manufacturing the fiber composite board. More particularly, this disclosure relates to thermoplastic organic fibers including maleic anhydride-containing polypropylene, a method for preparing the same, a light-weight fiber composite board using the thermoplastic organic fibers for a high performance car interior material, and a method for manufacturing the light-weight fiber composite board.

### BACKGROUND ART

Recently, there has been a great need for eco-friendly products to develop alternative energy sources in preparation for the exhaustion of crude oil and to prevent environmental pollution. In the field of automobile industries, automobile materials have been provided to have light weight to improve the fuel consumption efficiency and to reduce exhaust gas that is a main cause of environmental pollution. Under these circumstances, use of polymer composite materials as light materials substituting for heavy metallic materials has increased rapidly.

As composite materials for light-weight car interior materials, there have been used highly heat resistant and high-strength fiber reinforced plastic (FRP) materials obtained by melting polymer resin chips including thermoplastic olefin (TPO) such as polypropylene to provide a matrix, which, in turn, is reinforced with reinforcing fibers, such as glass fibers or carbon fibers, or thermosetting composite materials obtained by rubberizing thermoplastic polymers and unsaturated polyester resins.

Such materials have high quality superior to metallic materials, and thus are used in various applications. However, they are insufficient in terms of mechanical properties, such as impact resistance and fracture toughness, allow only a small range of deformation when they are deformed, and may not be reused, so that they still have a problem related to environmental pollution.

Meanwhile, more recently, thermoplastic polymer resins containing natural reinforcing materials, such as wood powder and natural fibers, added thereto have been injection molded and extruded, or thermoplastic organic fibers are blended with natural fibers and then formed into the shape of non-woven webs in order to provide materials substituting for the above-mentioned composite materials. The car interior materials thus obtained are molded through a stamping molding process using a hot press.

Such materials have been spotlighted due to their biocompatibility and light-weight. Unlike other known materials, they are amenable to a stamping molding process similar to a molding process for metals, and thus provide high productivity. In addition, the materials have higher freedom of design than metals. Therefore, use of the materials has increased more and more in various industrial fields.

However, after conducting intensive studies, we have found that the car interior materials obtained by blending thermoplastic polymer resins with natural materials have a limitation in their light-weighted production due to the low quality, low impact strength and high specific gravity resulting from the non-uniform dispersion occurring when wood powder or reinforcing fibers are added to thermoplastic polymer resins.

In addition, molding the materials directly by a hot press at high temperature after they are provided and distributed in the form of non-woven webs causes a problem of non-uniform fusion between the surface and inner layers. Moreover, binding force between polypropylene fibers used as a matrix and natural fibers used as reinforcing materials is low and insufficient to improve the strength. As a result, such materials have lower strength than the existing materials using glass fibers and thermosetting resins, and thus have a limited range of applications.

### DISCLOSURE OF INVENTION

### Technical Problem

This disclosure is directed to providing thermoplastic organic fibers based on maleic anhydride-containing polypropylene, which serve as thermoplastic organic fibers for use in matrix fibers of a composite fiber board, and have excellent wettability and adhesion in the interface with reinforcing fibers, such as natural fibers and organic and/or inorganic fibers, to improve the physical properties of the fiber board. This disclosure is also directed to a method for preparing the thermoplastic organic fibers, a light-weight fiber composite board using the thermoplastic organic fibers and a method for manufacturing the fiber composite board.

### Solution to Problem

In one general aspect, there is provided a method for preparing thermoplastic organic fibers, including: providing a resin of maleic anhydride (MA) copolymerized with polypropylene; and forming thermoplastic organic fibers from the copolymerized resin.

In an exemplary embodiment, the copolymerized resin may be in the form of chips obtained by melt compounding MA with polypropylene or in the form of powder obtained by solution copolymerization of MA with polypropylene.

In another embodiment, MA may be subjected to melt compounding or copolymerization with polypropylene in an amount of 0.1-6 wt %.

In still another embodiment, the operation of forming thermoplastic organic fibers may include: melt compounding the copolymerized resin with a polypropylene resin to provide chips for spinning, or blending the copolymerized resin with a polypropylene resin to provide a blend for spinning; and carrying out melt spinning of the chips for spinning or the blend for spinning to provide thermoplastic organic fibers based on MA-containing polypropylene.

In still another embodiment, the copolymerized resin may be added to the polypropylene resin in an amount of 1-50 wt %.

In still another embodiment, the chips for spinning may include MA in an amount of 0.01-5 wt % based on the total weight.

In still another embodiment, the operation of forming thermoplastic organic fibers may include: subjecting the chips for spinning including the copolymerized resin in the form of chips or powder to melt spinning to provide thermoplastic organic fibers based on MA-containing polypropylene.

In still another embodiment, the method may further include preparing sheath-core bicomponent fibers by carrying out conjugate spinning of the thermoplastic organic fibers, specifically the chips for spinning, as a sheath component, and organic fibers, specifically a high-melting point organic resin, as a core component.

In still another embodiment, the core component may be a polyamide-based polymer resin, polypropylene-based polymer resin or polyester-based polymer resin.

In still another embodiment, the core component may have a melting point of 160-270° C., particularly 200-270° C., and the sheath component may have a melting point of 110-180° C.

In still another embodiment, the core-sheath type composite fiber may include 40-70 wt % of a core component having a melting point of 160-270° C. and 30-60 wt % of a sheath component having a melting point of 110-180° C.

In another general aspect, there are provided thermoplastic organic fibers for use in a matrix of a fiber composite board, including a copolymerized resin of MA with polypropylene.

In an exemplary embodiment, the thermoplastic organic fibers may be provided by melt spinning of chips for spinning obtained by carrying out melt compounding of the copolymerized resin of MA with polypropylene and polypropylene resin chips.

In another embodiment, the thermoplastic organic fibers, particularly the chips for spinning, may be provided as a sheath component of sheath-core bicomponent fibers.

In still another embodiment, the thermoplastic organic fibers may have a thickness of 3-30 deniers and a length of 30-100 mm.

In still another general aspect, there is provided a fiber composite board using a matrix and reinforcing fibers. Particularly, the fiber composite board uses a copolymerized resin of MA with polypropylene as the matrix.

In still another embodiment, the reinforcing fibers may be: natural fibers selected from the group consisting of hemp fiber, jute fibers, flax fibers, abaca fibers, kenaf fibers, sisal fibers, coir fibers, banana fibers, cotton fibers and cellulose fibers; or organic or inorganic fibers selected from the group consisting of polyester fibers, polyamide fibers, polyacrylic fibers, polyvinyl alcohol fibers, aramid fibers, glass fibers, carbon fibers, boron fibers and basalt fibers.

In still another embodiment, the fiber composite board may include a matrix layer having 30-90 wt % of the matrix fibers and 10-70 wt % of the reinforcing fibers.

In still another embodiment, the fiber composite board may include: a matrix layer having 40-70 wt % of the matrix fibers and 30-70 wt % of the reinforcing fibers; and a surface layer attached to one surface or both surfaces of the matrix layer, and having 50-90 wt % of at least one selected from the matrix fibers, polypropylene fibers or sheath-core bicomponent fibers and 10-50 wt % of the reinforcing fibers.

In still another embodiment, the sheath-core bicomponent fibers may be formed of 40-70 wt % of a high-melting point core component and 30-60 wt % of a low-melting point sheath component, and may include sheath-core bicomponent fibers selected from: sheath-core bicomponent fibers using a low-melting point polyester-based resin having a melting point of 100-180° C. as a sheath component and a polyester-based resin having a melting point of 240-270° C. as a core component; sheath-core bi-component fibers using a polyethylene-based resin having a melting point of 100-140° C. as a sheath component and a polyester-based resin having a melting point of 240-270° C. as a core component; and sheath-core bicomponent fibers using a polypropylene-based resin having a melting point of 140-170° C. as a sheath component and a polyester-based resin having a melting point of 250-270° C. as a core component.

In still another general aspect, there is provided a car interior material including the fiber composite board.

In yet another general aspect, there is provided a method for manufacturing a fiber composite board, including: carrying out blending and fiber-opening of the thermoplastic organic fibers as matrix fibers and reinforcing fibers; subjecting the blended and opened fibers to carding to form fibrous webs; doubling the fibrous webs; carrying out needle punching of the doubled webs to provide non-woven webs; and carrying out preheating, hot fusion, pressurization and cooling of the non-woven webs to provide a composite board.

### Advantageous Effects of Invention

According to the embodiments disclosed herein, it is possible to overcome the problems related to limited improvement of strength caused by low wettability and adhesion between the organic materials used as a matrix according to the related art and reinforcing fibers. Particularly, according to this disclosure, maleic anhydride (MA) is copolymerized with polypropylene to provide a copolymerized resin (for example, a chip-like copolymerized resin is obtained by melt compounding or a powder-like copolymerized resin is obtained by solution copolymerization of MA with polypropylene). Instead of the matrix material used according to the related art, the copolymerized resin is used as matrix fibers when manufacturing a fiber-reinforced composite board in order to improve the wettability and adhesion in the interface with reinforcing fibers, such as natural fibers or organic and/or inorganic reinforcing fibers. As a result, it is possible to improve the physical properties of the resultant fiber composite board, including strength, modulus, heat resistance, impact absorbing property, noise absorbing property, etc. It is also possible to provide a porous light-weight fiber-reinforced composite board having a uniform thickness and improved moldability and dimensional stability. The fiber composite board may be used desirably as an eco-friendly car interior material or industrial material.

### BRIEF DESCRIPTION OF DRAWINGS

The above and other aspects, features and advantages of the disclosed exemplary embodiments will be more apparent from the following detailed description taken in conjunction with the accompanying drawings in which:

FIG. 1 is a schematic sectional view of a monolayer-structured car interior composite material according to an exemplary embodiment; and

FIG. 2 is a schematic sectional view of a bilayer-structured car interior composite material according to another exemplary embodiment.

### MODE FOR THE INVENTION

In some embodiments, a fiber-reinforced composite board is provided by using heterogeneous fibers having different melting characteristics. Herein, maleic anhydride (MA) is copolymerized with polypropylene (PP) to provide a copolymerized resin (for example, a chip-like copolymerized resin is obtained by melt compounding or a powder-like copolymerized resin is obtained by solution copolymerization of MA with PP), and then the copolymerized resin is formed into fibers to provide thermoplastic organic yarn fibers, which, in turn, are used as matrix fibers (matrix fibers of a fiber-reinforced composite board) having excellent wettability and adhesion with reinforcing fibers, such as natural fibers or organic or inorganic reinforcing fibers. When using the thermoplastic organic yarn fibers as matrix fibers of a fiber-reinforced composite board, it is possible to obtain a composite fiber board having improved physical properties and other properties including moldability.

The method for manufacturing a fiber-reinforced composite board disclosed herein is differentiated from a process of distributing MA-containing low-molecular weight PP powder onto a non-woven web. According to the process of distributing the powder onto a web, MA-containing PP powder or resin is used in an increased amount (e.g. 30-80 g/m²). There are additional problems in that uniform distribution is difficult, a large amount of loss may occur during the manufacture, a complicated process is required, and the finished board product shows non-uniform quality.

Unlike the methods according to the related art, the method disclosed herein uses a relatively low amount of yarn fibers to provide a fiber-reinforced composite board having excellent physical properties. In other words, since the method uses fibers, it is possible to accomplish uniform dispersion, to reduce or prevent a loss during the manufacture, to simplify the process, and to obtain a fiber-reinforced composite board having excellent quality and physical properties.

First, preparation of the thermoplastic organic yarn fibers according to some embodiments will be described hereinafter.

In some embodiment, MA is copolymerized with PP to provide a copolymerized resin. For example, MA is subjected to melt compounding with PP to provide a chip-like copolymerized resin, or MA is solution copolymerized with PP to provide a powder-like copolymerized resin.

The copolymerized resin thus obtained is then formed into fibers to provide thermoplastic organic fibers. As described hereinafter, the copolymerized resin may be formed into spun fibers through melt spinning or may be formed into sheath-core bicomponent fibers.

MA may be copolymerized with PP in a weight ratio of 0.1-6 wt % to improve the wettability and adhesion in the interface with reinforcing fibers, and thus to improve the physical properties of the resultant composite board (wherein the PP is low-molecular weight PP, for example, having a molecular weight less than about 100,000).

In an exemplary embodiment, upon the copolymerization of MA with PP, the presence of an excessive amount of unreacted monomers and materials, byproducts, etc., makes it difficult to form the fibers through melt spinning due to fiber milling. Thus, it is intended to obtain a powder-like or chip-like copolymerized resin with a high purity of at least 70% and having a low amount of impurities by preventing the presence of the above-mentioned materials.

Then, the thus obtained copolymerized resin is further subjected to melt compounding with a PP resin to provide chips for spinning, or subjected to physical blending with a PP resin to provide a blend for spinning. Subsequently, the chips or blend for spinning is subjected to melt spinning to obtain yarn fibers (i.e., staple fibers), from which web-like non-woven cloth is formed.

The PP resin may be provided as PP chips or pellets having a predetermined size and amenable to a spinning process for preparing fibers.

In general, the PP chips are high-molecular weight PP chips having a molecular weight of 100,000 or higher. PP chips having a molecular weight of several thousands to several tens of thousands are not amenable to a spinning process for preparing fibers.

In an exemplary embodiment, the powder-like or chip-like copolymerized resin may be further subjected to melt compounding in combination with a PP resin, thereby providing chips for spinning.

This is because spinning using chips and powder having different specific gravity values makes it difficult to perform homogeneous blending. Also, this is because even if a copolymerized resin obtained by melt compounding is present as chips, it does not allow homogeneous blending unless it is formed to have the same size as the PP chips. When such a non-homogeneous blend is spun into fibers, it is difficult to perform high-quality spinning due to such problems as fiber filling, etc. Therefore, a melt compounding machine is used to provide chips for spinning and to induce uniform concentration and blending, thereby providing high-quality fibers.

In a non-limiting example, a MA-PP copolymerized resin, such as a MA-PP copolymerized resin containing 0.1-6 wt % of MA may be added to PP chips in an amount of 1-50 wt %, the copolymerized resin and the PP chips blended physically, and then subjected to melt spinning to provide fibers.

In a non-limiting example, a MA-PP copolymerized resin, particularly a MA-PP copolymerized resin containing 0.1-6 wt % of MA may be added to PP chips in an amount of 1-50 wt %, and then melt compounding may be carried out in such a manner that the MA content may be 0.01-5 wt % to provide chips for spinning. In a non-limiting example, the MA content in the chips for spinning may be 0.01-5 wt % in view of uniformity of fibers.

In an exemplary embodiment, the thermoplastic organic fibers may have a thickness of 3-30 deniers and a length of 30-100 mm. More particularly, the thermoplastic organic fibers may have a strength of 1.0-5 g/d, elongation of 30-400%, thickness of 3-30 deniers, length of 30-100 mm, and a crimp number of 5-15 crimps/inch.

In an exemplary embodiment, the thermoplastic organic fibers, specifically the chips for spinning, may be used as a sheath component, and organic fibers, specifically high-melting point organic resins, such as polyester resins, polyamide resins or PP resins, may be used as a core component to provide sheath-core bicomponent fibers.

In an exemplary embodiment, the sheath-core bicomponent fibers may include a core component having a melting point of 160-270° C. and a sheath component having a melting point of 110-180° C.

In an exemplary embodiment, the sheath-core bicomponent fibers may include 40-70 wt % of a core component having a melting point of 160-270° C. and 30-60 wt % of a sheath component having a melting point of 110-180° C.

Hereinafter, a composite board using the thermoplastic organic fibers will be described in detail with regard to a method for manufacturing a composite board by using the thermoplastic organic fibers as a matrix in combination with reinforcing fibers.

The MA-PP fibers obtained as described above are used as a matrix and natural fibers or organic or inorganic fibers are used as reinforcing fibers, and then the matrix and reinforcing fibers are blended in a predetermined ratio. Then, the blended fibers are formed into non-woven webs through a carding process.

After that, the non-woven webs are subjected continuously to preheating, fusion, compression and cooling processes so as to have a constant thickness and density. In this manner, it is possible to obtain a porous light-weight fiber-reinforced composite board having improved physical properties, such as strength, modulus, heat resistance, impact absorbing property and noise absorbing property, as well as improved moldability and dimensional stability.

The MA-PP fibers used as a matrix are melted completely during the preheating, fusion and compression processes, thereby functioning as a binding agent, with which the reinforcing fibers are bonded among themselves. Thus, it is possible to realize high wettability, adhesion and crystallization in the interface with the reinforcing fibers.

In other words, when the MA-containing PP is used to form fibers and the resultant fibers are used as matrix fibers, it is possible to realize adhesion between the matrix fibers and reinforcing fibers over an increased area, and to increase the degree of crystallization by forming larger crystals through gradual crystallization. Such an increased degree of crystallization may result in an increase in strength and modulus, and may facilitate formation of a fine internal structure, leading to improvement of physical properties, such as noise absorbing property. Surprisingly, unlike the matrix fibers and reinforcing fibers used according to the related art, the matrix fibers and reinforcing fibers disclosed herein have a dense and large interface to allow firm binding between them.

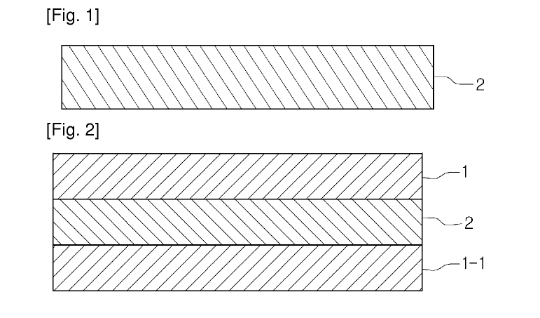

FIG. 1 is a schematic sectional view of a monolayer-structured car interior composite material according to an exemplary embodiment.

As shown in FIG. 1, in order to manufacture a light-weight fiber-reinforced composite board, the MA-PP fibers or core-sheath bicomponent fibers containing MA-PP fibers are provided as matrix fibers in an amount of 30-90 wt %, and natural fibers or organic or inorganic reinforcing fibers are provided in an amount of 10-70 wt % to provide an integrally formed matrix layer 2. The matrix layer is used to provide a monolayer-structured light-weight fiber-reinforced composite board.

FIG. 2 is a schematic sectional view of bilayer-structured car interior composite material according to another exemplary embodiment.

As shown in FIG. 2, in order to manufacture a light-weight fiber-reinforced composite board, the MA-PP fibers or core-sheath bicomponent fibers containing MA-PP fibers are provided as matrix fibers in an amount of 40-70 wt %, and natural fibers or organic or inorganic reinforcing fibers are provided in an amount of 30-60 wt % to provide an integrally formed matrix layer 2. In addition, surface layers 1, 1-1 are attached to one surface or both surfaces of the matrix layer 2 (FIG. 2 shows surface layers attached to both surfaces of the matrix layer), wherein the surface layer includes 50-90 wt % of the MA-PP fibers, core-sheath bicomponent fibers containing MA-PP fibers, or other known core-sheath bicomponent fibers containing no MA-PP fibers or PP fibers, in combination with 10-50 wt % of natural fibers or organic or inorganic reinforcing fibers. The matrix layer and the surface layers may be used to provide a multilayer-structured light-weight fiber-reinforced composite board.

In an exemplary embodiment, an additional fibrous layer, such as woven cloth, knit, non-woven web, film or scrim, may be optionally attached to one surface or both surfaces of the monolayer, bilayer or tri-layer structure in order to improve the functionality or strength of the structure.

In some embodiments, the light-weight fiber-reinforced composite board may be manufactured by the method described hereinafter.

First, the matrix fibers and the reinforcing fibers are blended/opened uniformly, and the blended/opened fibers are passed through a cylindrical carding machine to form thin fibrous webs (carding operation).

Next, the fibrous webs are subjected to doubling to form multiple layers, which, in turn, are fixed by needle punching to provide nonwoven webs.

Then, the non-woven webs are sent to a continuous type composite board manufacturing system so that they are subjected to continuous preheating, hot fusion, pressurization, cooling, foaming and cutting processes, thereby providing a light-weight fiber-reinforced composite board.

In another exemplary embodiment, to realize various functionalities, such as noise absorbing property, heat retaining property, heat insulating property and appearance, an additional fibrous layer (e.g. woven cloth, knit, non-woven web, film or scrim) may be attached to one surface or both surfaces of the matrix layer; or to one side or both sides of the surface layer attached to the matrix layer. In this manner, it is possible to manufacture various types of multilayer-structured light-weight fiber-reinforced composite board.

In still another exemplary embodiment, to realize different degrees of strength and modulus, the MA-PP fibers functioning as an adhesive when melted may be blended with PP fibers used generally as matrix fibers in the art in a predetermined ratio. The blending ratio may be 30-70 wt % of MA-PP fibers to 70-30 wt % of general PP fibers.

In an embodiment, particular examples of the reinforcing fibers that may be used include natural fibers, such as hemp fibers, jute fibers, flax fibers, abaca fiber, kenaf fibers, sisal fibers, coir fibers, banana fibers, cotton fibers and cellulose fibers. For example, the natural fibers may have a length of 30-200 mm.

In addition to the natural fibers, the reinforcing fibers that may be used also include organic or inorganic fibers, such as polyester (PET) fibers, polyamide (PA) fibers, glass fibers, carbon fibers and basalt fibers.

The matrix fibers may be blended with the reinforcing fibers in various ratios to provide non-woven webs.

Then, the non-woven webs are passed through a continuous composite board manufacturing system so that they are subjected to preheating, fusion, compression and cooling processes. In this manner, it is possible to obtain a porous light-weight fiber-reinforced composite board having improved strength, modulus, noise absorbing property and heat resistance. Such a continuous composite board manufacturing system is known to those skilled in the art. For example, an exemplary system is disclosed in PCT/KR02/00658 (title: METHOD AND APPARATUS FOR MANUFACTURING COMPSITE MATERIALS HAVING IMPROVED QUALITY). The system includes a preheating unit, hot fusion unit, pressurization unit, cooling unit, foaming unit and a cutting unit to carry out a continuous process, and allows easy control of density, strength and thickness of the composite board depending on particular use. The resultant composite board may be formed into molded articles, for example, by using a molding machine for car ceiling materials. In addition, multilayer-structured composite non-woven webs may be formed into molded articles by using a process merely including a preheating unit, molding unit and a cooling unit without forming a composite board.

The resultant fiber-reinforced composite board may have improved mechanical strength resulting from high wettability between the matrix fibers and reinforcing fibers, and may provide light weight, noise absorbing property, heat retaining property, heat insulating property and impact absorbing property resulting from formation of a fine porous structure.

Further, the resultant fiber-reinforced composite board uses the thermoplastic organic fibers and natural fibers alone and has excellent recyclability, and thus may be useful as various eco-friendly materials, such as eco-friendly car interior parts and industrial materials. Non-limiting examples of the use of the composite board include package trays, door trims, head liners, seat backs, etc.

The examples and experiments will now be described. The following examples and experiments are for illustrative purposes only and not intended to limit the scope of this disclosure.

Preparation of Thermoplastic Organic Fibers Based on Maleic Anhydride (MA) and Polypropylene (PP)

PP having a molecular weight between 50,000 and 100,000 is copolymerized with maleic anhydride, and impurities, including unreacted materials and byproducts, are removed therefrom to obtain a MA-PP copolymerized resin having a purity of 90% or higher and a MA content of 3 wt %.

The copolymerized resin is blended with PP resin chips (molecular weight: about 250,000) in a ratio of 10 wt %:90 wt %, and the resultant blend is subjected to melt compounding to provide chips for spinning. Then, the chips are melt spun by using a melt spinning system to obtain thermoplastic organic fibers.

The resultant thermoplastic organic fibers have a thickness of about 10 deniers, length of about 64 mm, strength of about 2.3 g/d, elongation of 250% and a crimp number of 12 crimps/inch.

Manufacture of Fiber-Reinforced Composite Board

### COMPARATIVE EXAMPLE 1

In this example, 60 wt % of PP fibers are used as a matrix and 40 wt % of jute fibers are used as reinforcing fibers. The fibers are blended/opened and passed through a cylindrical carding machine to obtain fibrous webs.

The fibrous webs are subjected to needle punching to obtain non-woven webs having a weight of 1000 g/m², and passed through preheating, hot fusion, pressurization, cooling and cutting operations by a continuous type fiber-reinforced composite board manufacturing system at a rate of 6 m/min, thereby providing a melt pressurized light-weight composite fiber board having a thickness of 4 mm.

### EXAMPLE 1-1

In this example, 60 wt % of the MA-PP fibers obtained as described above are used as a matrix and 40 wt % of jute fibers are used as reinforcing fibers. The fibers are blended/opened and passed through a cylindrical carding machine to obtain fibrous webs.

The fibrous webs are subjected to needle punching to obtain non-woven webs having a weight of 1000 g/m², and passed through preheating, hot fusion, pressurization, cooling and cutting operations by a continuous type fiber-reinforced composite board manufacturing system at a rate of 6 m/min, thereby providing a melt pressurized light-weight composite fiber board having a thickness of 4 mm.

### EXAMPLE 1-2

In this example, 40 wt % of the MA-PP fibers and 20 wt % of PP fibers are used as a matrix and 40 wt % of jute fibers are used as reinforcing fibers. The fibers are blended/opened and passed through a cylindrical carding machine to obtain fibrous webs. The fibrous webs are subjected to needle punching to obtain non-woven webs having a weight of 1000 g/m², and passed through preheating, hot fusion, pressurization, cooling and cutting operations by a continuous type fiber-reinforced composite board manufacturing system at a rate of 6 m/min, thereby providing a melt pressurized light-weight composite fiber board having a thickness of 4 mm.

### COMPARATIVE EXAMPLE 2

In this example, 50 wt % of PP fibers are used as a matrix and 50 wt % of jute fibers are used as reinforcing fibers. The fibers are blended/opened and passed through a cylindrical carding machine to obtain thin fibrous webs.

The thin fibrous webs are subjected to needle punching to obtain a non-woven web having a weight of 600 g/m², and the non-woven web is used as an inner layer.

In addition, 70 wt % of PP fibers and 30 wt % of polyester (PET) are blended/opened uniformly and passed through a carding machine to obtain thin fibrous webs. The thin fibrous webs are subjected to needle punching to obtain non-woven webs having a weight of 200 g/m², and the non-woven webs are used as surface layers.

The surface layers are positions on both surfaces of the inner layer to carry out doubling so that the whole layers are stacked, and the resultant composite non-woven webs are fixed by needle punching. After providing the composite non-woven webs by needle punching, the non-woven webs are passed through preheating, hot fusion, pressurization, cooling and cutting operations by a continuous type fiber-reinforced composite board manufacturing system at a rate of 6 m/min, thereby providing a light-weight composite fiber board having a weight of 1000 g/m² and a thickness of 4.5 mm.

### EXAMPLE 2

In this example, 50 wt % of the MA-PP fibers obtained as described above are used as a matrix and 50 wt % of jute fibers are used as reinforcing fibers. The fibers are blended/opened and passed through a cylindrical carding machine to obtain thin fibrous webs. The thin fibrous webs are subjected to needle punching to obtain a non-woven web having a weight of 600 g/m², and the non-woven web is used as an inner layer.

In addition, 70 wt % of the MA-PP fibers and 30 wt % of PET are blended/opened uniformly and passed through a carding machine to obtain thin fibrous webs. The thin fibrous webs are subjected to needle punching to obtain non-woven webs having a weight of 200 g/m², and the non-woven webs are used as surface layers.

The surface layers are positions on both surfaces of the inner layer to carry out doubling so that the whole layers are stacked, and the resultant composite non-woven webs are fixed by needle punching. After providing the composite non-woven webs by needle punching, the non-woven webs are passed through preheating, hot fusion, pressurization, cooling and cutting operations by a continuous type fiber-reinforced composite board manufacturing system at a rate of 6 m/min, thereby providing a light-weight composite fiber board having a weight of 1000 g/m² and a thickness of 4.5 mm.

### TEST EXAMPLE

The composite fiber boards according to the above examples are tested as described hereinafter to analyze and evaluate their qualities.

As used herein, machine direction (MD) means the direction along which the corresponding product is manufactured, and across-machine direction (AMD) means the direction perpendicular to MD.

Flexural strength and flexural modulus values are determined by the standard test method of ISO 178 using a sample size of 50×200 mm, span width of 100 mm and a measuring rate of 50 mm/min.

Sagging properties (sag) are determined by making a sample with a size of 75×300 mm, fixing one side of the sample to a jig by a length of 25 mm, introducing the sample into an environmental test chamber, maintaining the sample at 90° C. for 5 hours, at −40° C. for 5 hours, and at 50° C. under a humidity of 95% for 5 hours, and then evaluating the resistance of the sample board against heat, low temperature and humidity. The reported values are obtained by measuring how much the end of the sample opposite to the side fixed to the jig sinks downwards (unit: mm).

Noise absorbing properties are determined by comparing average values (NRC) of noise absorbing coefficients measured at 250, 500, 1000 and 2000 Hz by the impedance tube method with each other.

The test results are shown in the following Table 1.

TABLE 1

| | | | | Flexural strength | | Flexural modulus | | | | Noise absorbing |
|---|---|---|---|---|---|---|---|---|---|---|
| | Weight | Thickness | Density | (N) | | (N/mm) | | Sag (mm) | | property (NRC) |
| | (g/m²) | (mm) | (g/cm³) | MD | AMD | MD | AMD | MD | AMD | — |
| Comp. Ex. 1 | 1000 | 4.0 | 0.25 | 27 | 22 | 5.5 | 3.9 | 9.3 | 15.4 | 0.17 |
| Ex. 1-1 | 1000 | 4.0 | 0.25 | 39 | 35 | 8.7 | 7.3 | 4.1 | 7.9 | 0.25 |
| Ex. 1-2 | 1000 | 4.0 | 0.25 | 36 | 33 | 7.9 | 6.5 | 5.2 | 8.4 | 0.23 |
| Comp. Ex. 2 | 1000 | 4.5 | 0.24 | 25 | 20 | 4.5 | 3.5 | 8.9 | 13.1 | 0.19 |
| Ex. 2 | 1000 | 4.5 | 0.24 | 37 | 34 | 8.1 | 6.9 | 5.2 | 8.2 | 0.27 |

As can be seen from the above results, Example 1 using MA-PP fibers as a matrix show the highest flexural strength and flexural modulus. In addition, as compared to the samples using PP fibers as a matrix, it shows significantly improved noise absorbing property and sagging property due to the formation of a fine porous structure resulting from excellent wettability with natural fibers.

As demonstrated above, the thermoplastic organic fibers according to some embodiments disclosed herein solve the problem of a limitation in improvement of strength caused by low wettability and adhesion between the thermoplastic organic materials used as a matrix according to the related art and reinforcing fibers. The fiber composite board disclosed herein allows designing a bulky multilayer structure having a fine porous layer, and has light weight and high durability and recyclability. The composite board may be utilized as car interior materials and various building and industrial materials, such as partitions, furniture and plywood.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A method for preparing thermoplastic organic fibers for use in a matrix of a fiber composite board, comprising:
copolymerizing maleic anhydride (MA) with polypropylene to provide a copolymerized resin; and
forming thermoplastic organic fibers from the copolymerized resin.

2. The method according to claim 1, wherein the copolymerized resin is in the form of chips obtained by melt compounding MA with polypropylene or in the form of powder obtained by solution copolymerization of MA with polypropylene.

3. The method according to claim 1, wherein MA is copolymerized with polypropylene in an amount of 0.1-6 wt %.

4. The method according to claim 1, wherein said forming thermoplastic organic fibers comprises:
melt compounding the copolymerized resin with a polypropylene resin to provide chips for spinning, or blending the copolymerized resin with a polypropylene resin to provide a blend for spinning; and
carrying out melt spinning of the chips for spinning or the blend for spinning to provide thermoplastic organic fibers based on MA-containing polypropylene.

5. The method according to claim 4, wherein the copolymerized resin is added to the polypropylene resin in an amount of 1-50 wt %.

6. The method according to claim 4, wherein the chips for spinning comprises MA in an amount of 0.015 wt % based on the total weight.

7. The method according to claim 1, which further comprises preparing sheath-core bicomponent fibers by using the thermoplastic organic fibers as a sheath component, and organic fibers as a core component.

8. The method according to claim 7, wherein the core component is a polyamide-based composite fiber, polypropylene-based composite fiber or polyester-based composite fiber.

9. The method according to claim 7, wherein the core-sheath type composite fiber comprises 40-70 wt % of a core component having a melting point of 160-270° C. and 30-60 wt % of a sheath component having a melting point of 110-180° C. .

10. Thermoplastic organic fibers obtained by the method according to claim 1 for use in a matrix of a fiber composite board.

11. A fiber composite board comprising the thermoplastic organic fibers as defined in claim 10 as a matrix.

12. Thermoplastic organic fibers for use in a matrix of a thermoplastic organic fiber composite board, comprising a copolymerized resin of maleic anhydride with polypropylene.

13. The thermoplastic organic fibers according to claim 12, which are obtained by melt spinning of chips for spinning prepared by carrying out melt compounding of the copolymerized resin of maleic anhydride with polypropylene and polypropylene resin chips.

14. The thermoplastic organic fibers according to claim 12, which are provided as a sheath component of sheath-core bicomponent fibers.

15. The thermoplastic organic fibers according to claim 12, which have a thickness of 3-30 deniers and a length of 30-100 mm.

16. A fiber composite board using a matrix and reinforcing fibers, wherein the matrix comprises a copolymerized resin of maleic anhydride with polypropylene.

17. The fiber composite board according to claim 16, wherein the thermoplastic organic fibers are obtained by melt spinning of chips for spinning prepared by carrying out melt compounding of the copolymerized resin of maleic anhydride with polypropylene and polypropylene resin chips.

18. The fiber composite board according to claim 16, wherein the reinforcing fibers are natural fibers selected from the group consisting of hemp fiber, jute fibers, flax fibers, abaca fibers, kenaf fibers, sisal fibers, coir fibers, banana fibers, cotton fibers and cellulose fibers; or organic or inorganic fibers selected from the group consisting of polyester fibers, polyamide fibers, polyacrylic fibers, polyvinyl alcohol fibers, aramid fibers, glass fibers, carbon fibers, boron fibers and basalt fibers.

19. The fiber composite board according to claim 16, which comprises a matrix layer having 30-90 wt % of the matrix fibers and 10-70 wt % of the reinforcing fibers.

20. The fiber composite board according to claim 16, which comprises:
a matrix layer having 40-70 wt % of the matrix fibers and 30-70 wt % of the reinforcing fibers; and
a surface layer attached to one surface or both surfaces of the matrix layer, and having 50-90 wt % of at least one selected from the matrix fibers, polypropylene fibers or sheath-core bicomponent fibers and 10-50 wt % of the reinforcing fibers.

21. The fiber composite board according to claim 19, which further comprises a fibrous layer on one side or both sides thereof.

22. The fiber composite board according to claim 20, which further comprises a fibrous layer on one side or both sides thereof.

23. The fiber composite board according to claim 20, wherein the sheath-core bicomponent fibers are formed of 40-70 wt % of a high-melting point core component and 30-60 wt % of a low-melting point sheath component, and are selected from:
sheath-core bicomponent fibers using a low-melting point polyester-based resin fiber having a melting point of 100-180° C. as a sheath component and a polyester-based resin fiber having a melting point of 240-270 ° C. as a core component;
sheath-core bicomponent fibers using a polyethylene-based resin fiber having a melting point of 100-140° C. as a sheath component and a polyester-based resin fiber having a melting point of 240-270 ° C. as a core component; and
sheath-core bicomponent fibers using a polypropylene-based resin fiber having a melting point of 140-170 ° C. as a sheath component and a polyester-based resin fiber having a melting point of 250-270 ° C. as a core component.

24. A car interior material comprising the fiber composite board according to claim 1.

25. A method for manufacturing a fiber composite board, comprising:
carrying out blending and fiber-opening of the thermoplastic organic fibers according to claim 1 as matrix fibers in combination with reinforcing fibers;
subjecting the blended and opened fibers to carding to form fibrous webs;
doubling the fibrous webs;
carrying out needle punching of the doubled webs to provide non-woven webs; and
carrying out preheating, hot fusion, pressurization and cooling of the non-woven webs to provide a composite board.
